(19) United States
(12) Patent Application Publication
(10) Pub. No.: US 2016/0244230 A1
(43) Pub. Date: Aug. 25, 2016

(54) DISSIPATION OF STATIC ELECTRICITY ON A PRINTED FILM

(71) Applicant: American Packaging Corporation, Columbus, WI (US)

(72) Inventor: John L. Muehlbauer, Monona, WI (US)

(73) Assignee: American Packaging Corporation, Columbus, WI (US)

(21) Appl. No.: 15/052,142

(22) Filed: Feb. 24, 2016

Related U.S. Application Data
(60) Provisional application No. 62/119,993, filed on Feb. 24, 2015.

(51) Int. Cl. B65D 65/42; B41F 3/18

(52) U.S. Cl. CPC B65D 65/42; B41F 3/18

(57) ABSTRACT

An improved printed film that achieves the dissipation of static electricity is disclosed. The improved film dissipates charge that is typically built up during the processing, handling and use of such film. One embodiment involves the selective overprinting of coating material(s) to form a continuous path that is electrically dissipative and/or conductive, which thereby enables the dissipation or equalization of static charge.

This application claims priority under 35 U.S.C. §119(e) from U.S. Provisional Patent Appl. No. 62/119,993 for DISSIPATION OF STATIC ELECTRICITY ON A PRINTED FILM, filed Feb. 24, 2015 by John L. Muehlbauer, which is also hereby incorporated by reference in its entirety.

Disclosed is an improved printed film, and an associated method of production, that achieves the dissipation of static electricity typically built up during the processing, handling and use of such films. One embodiment includes the selective application of material(s), for example by overprinting, that are electrically dissipative and/or conductive. More specifically static electricity on the film is discharged or equalized through a coating that is selectively applied to electrically interconnected regions to provide a dissipative path.

### BACKGROUND AND SUMMARY

In manufacturing and packaging industries static electricity can interfere with the handling of parts and materials. Arcs and sparks produced by static discharge can also create dangerous explosions in a variety of hazardous environments. Accordingly countermeasures have been developed to control and mitigate the counterproductive effects of electrostatic energy and its discharge (e.g., electrostatic discharge or ESD). However, in the general manufacturing environment personnel, as well, are all too often subjected to static discharges that can be uncomfortable and in some cases hazardous. While the physiological effects are negligible the psychological consequences from receiving an ESD microshock can have a negative effect on an operator. A person will begin to feel an effect from a discharge of as little as 1 kV and will typically experience an unpleasant consequence from discharges at a level of 2 kV and higher. Notably voltages in the range of 10-25 kV can be encountered under certain conditions. And, while not generally lethal, due to the low current level, such a shock can induce muscular contractions, or may at least cause the personnel to be distracted from the task(s) being performed because of such shocks or in anticipation of such shocks.

Static charge generally arises from an imbalance of charges within, or on, a surface that is created when two surfaces come into contact and then are separated—particularly when one of the surfaces has a high resistance to electrical current, such as in packaging films. Minimization of the potential for shocking is achieved by dissipating or equalizing the charge with that on adjacent objects or surfaces. The unbalanced charge remains “static” until it is capable of being discharged or neutralized by direct current flow to a point (or person) providing a different voltage potential. It is also known that surfaces may be treated with antistatic agents to, at least temporarily, dissipate the charge.

Typical polymer-based materials are known in the packaging and printing industry as being electrically non-conductive and, in fact, such materials are used as dielectrics because of their resistance to electron flow. Attempts at imparting electrically conductive properties to polymers generally require the inclusion of conductive materials, such as carbon or graphite, as a filler. While the inclusion of a uniformly dispersed material, such as carbon, provides an effective electrical pathway it also imparts a predominately black color to any polymeric material into which it is incorporated. Therefore, there is a requirement in the printing and packaging industry for materials which are more practical and aesthetically pleasing.

One method for creating a conductive polymer is either by laminating or coating a conducting layer onto the polymer sheet. Typical coatings consist of oxides such as indium tin, aluminum, zinc, as well as carbon tubes, graphene and polythiophenes. The development of an electrically conductive coating on a sheet is particularly important in the field of packaging where static may be created or induced as the film is being manufactured and transported over, and through rollers during the manufacturing processes, and is further created during a coating or lamination process as well as during the slitting or finishing procedures. Accordingly, films such as biaxially oriented polypropylene (OPP), which come into contact with an operator during the aforementioned processes, have the potential for causing an ESD and associated shock, particularly during operations such as splicing, roll handling including changeover, etc.

Static electricity is a common occurrence in web converting operations. Some materials tend to have a higher potency to build static charge. In accordance with an embodiment disclosed herein one such film material is biaxially oriented polypropylene (OPP), and an application in which such a material is used includes use as a printed overwrap film for tobacco cigarette cartons.

At a manufacturing facility where the OPP film is used to wrap cigarette cartons on high speed converting lines, ESD or static electric shock, is experienced by line operators. The electrostatic discharge often occurs at the point where an operator is preparing a roll of printed OPP film for a splice over onto a new roll of OPP near the running roll of unwinding OPP film. This electrostatic discharge is strong enough to cause employee complaints.

Referring to FIG. 11, static electricity, by description, is an imbalance of electric charges within or on the surface of a material (e.g., the surface of FIG. 1). In “Electrostatics in Web Handling”, a presentation by Kelly Robinson, P E, PhD, the stages of repeated contact and separation of surfaces 1 and 2 (see e.g. (A)-(C)) causes the buildup of static charge represented by the “+” and “−” symbols. The charge is held by the material (acting as an insulator) until a means for the charge to escape is created either as an electric current or electrical discharge. The control and mitigation of static charge is not always clear cut, meaning there are devices that claim to neutralize static or minimize static and yet, electrostatic discharges can still be experienced when working with a material with an excessive static charge. The description above can pertain to the rewinding and unwinding of OPP Film.

Therefore it is an object of the disclosed embodiments to combine a substrate and a conductive composition, applied in a plurality of separately patterned regions on a surface of said film, to dissipate any acquired static charge.

Another object of the disclosed embodiments is to provide a conductive trace or similar path that interconnects the patterned regions so as to increase the static dissipative area on the film surface.

Disclosed in embodiments herein is a packaging film, including: a film substrate (e.g., biaxially oriented polypropylene (OPP)); and a conductive lacquer applied in a plurality of separately patterned regions on a surface of said film to dissipate static created during the handling (e.g., moving, rolling, “transporting,” etc.) of said film at its manufacture and further induced through the handling (e.g., moving, rolling, “transporting,” etc.) of the film during its converting (e.g., printing, slitting).

Further disclosed in embodiments herein is a method of producing a packaging film, including: providing a film substrate (e.g., OPP); and applying to a surface of said film substrate, a patterned conductive lacquer to dissipate static created by handling (e.g., moving, rolling, transporting, etc.) of the film.

### BRIEF DESCRIPTION OF THE DRAWINGS

FIG. 1 is a schematic top view of a printed film from a web press showing selective areas of an applied coating material;

FIG. 2 An enlarged, post-slitting view of a roll of film with traces interconnecting the coated regions in accordance with a disclosed embodiment;

FIG. 3 is an illustrative example of a packaging wrapper for a cigarette carton in an enlarged view of the patterns illustrated in FIGS. 1 and 2;

FIG. 4 is a diagrammatic representation of a method for ESD dissipation via a grounding path from a web film to ground;

FIGS. 5A-5C are a series of related graphs illustrating the results obtained from testing of Example A and the relative resistance of various manually-applied conductive ink traces;

FIG. 6 is a graph showing the results relative to Example B, particularly the surface charge of a control web;

FIGS. 7-9 are graphs showing the results relative to Example B, particularly the results of traces at intervals of approx. 6 in., 26 in., and 100 ft.;

FIG. 10 is a graph showing the relative results of the various trace frequencies considered in Example B; and

FIG. 11 is an illustrative example characterizing the generation of an electrostatic charge.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

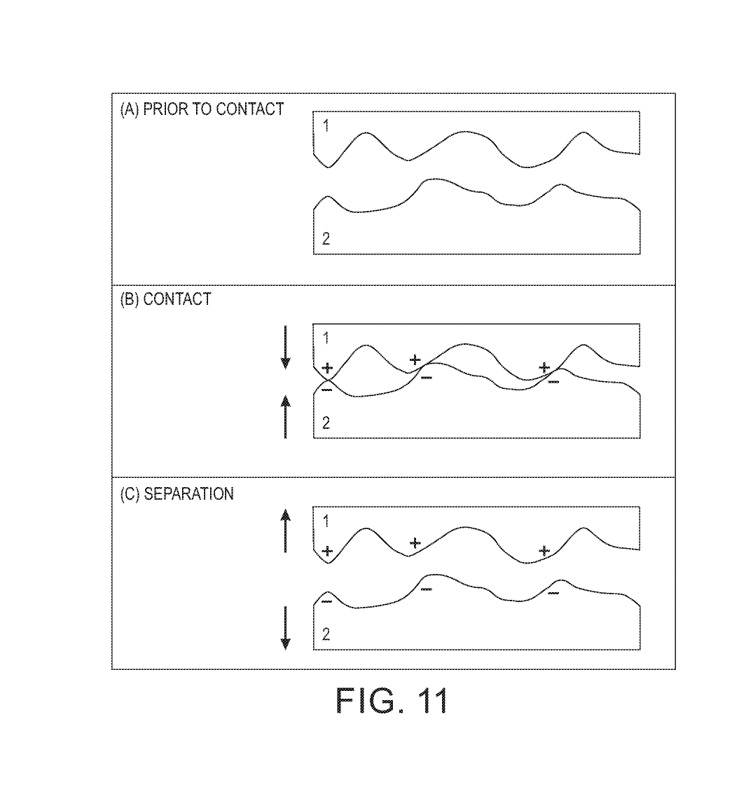

As noted above, static electricity, by description, is an imbalance of electric charges that build up within or on the surface of a material (see e.g., FIG. 11). In the case of a film, the charge is held by the material (acting as an insulator) until the charge is dissipated as an electric current or electrical discharge. With electrostatic charge mitigation equipment, electrostatic discharge can be experienced even though such equipment is installed on processing lines. The equipment and materials that are known to industry for mitigating static charge in materials are well known and can range in price and performance. Table 1 (below) provides a list of such equipment.

Even when utilizing equipment described in Table 1, electrostatic discharge can be experienced by individuals handling materials that have a potential to acquire electrostatic charge. Another factor that is important to the potency (potential) of electrostatic charge build-up is humidity in an environment. Humidifiers can be used to raise the moisture level in a room and create a semi-conductive environment that minimizes the build-up of charge, or that dissipates charge that is built-up. More specifically, the humidity in a room creates an avenue for the excess charge to escape through water's naturally occurring conductivity. The humidification of an environment, though potentially useful in lowering electrostatic discharge, can be a prohibitively expensive investment for a large space.

TABLE 1

| Description | Type | Cost | Performance/Comments |
|---|---|---|---|
| Static Brush | Passive | Low | Sufficient to suppress sparks and lower dust attraction. |
| | | | No external power is needed. Ineffective at low levels |
| | | | of charge. Broken brush bristles are a source of |
| | | | contaminaton. |
| Tinsel | Passive | Low | Sufficient to suppress sparks and lower dust attraction. |
| | | | No external power is needed. Ineffective at low levels |
| | | | of charge. Performance can degrade quickly with time |
| | | | as tinsel strands become matted. |
| Static String ™, | Passive | Low | Sufficient to suppress sparks and lower dust attraction. |
| Static Elastic ™ | | | No external power is needed. Ineffective at low levels |
| | | | of charge. More robust that tinsel. |
| Ionizing Air | Active | Medium | Intended for applications where parts have a long |
| Blower | | | residence time in the airflow (e.g. electonic work |
| | | | stations). Can dissipate low levels of charge. Devices |
| | | | can have a long life with periodic maintenance. |
| Shockless Pin | Active | Medium | Intended for use in solvent rated areas or where there is |
| Array Ionizer | | | a possibility that a person could touch an ionizing pin. |
| | | | Relatively high ion output. Devices can have a long |
| | | | life (years) with periodic maintenance. |
| High Output | Active | Medium | Intended for high speed (short residence time) |
| Pin Array | | | applications. Dependign on the geometry, ionizers can |
| Ionizer | | | be located some distance (several feet) from charge to |
| | | | be dissipated. Devices can have a long life (years) with |
| | | | periodic maintenance. |
| Radioactive | Active | High | Alpha and Beta emitters are commercially available. No |
| Source | | | external power is needed. Intended for applications where |
| | | | external power and/or light is not permitted. Regulatory |
| | | | compliance and regular inspections are burdensome. |
| Corona Wire | Active | High | Highest performance in terms of ion output and uniformity. |
| Ionizer | | | Used extensively in photocopiers. Regular maintenance |
| | | | and cleaning are essential to maintain performance. |

(Source: “Electrostatics in Web Handling”, presentation, Kelly Robinson, PE, PhD)

The embodiments disclosed herein include a conductive material applied to a biaxially oriented polypropylene (OPP) film to create a dissipative region on the surface of the film (e.g., conductive) and which thereby provides a path so that the electrostatic charge can escape the film material that is acting as an insulator and holding the excessive charge. The disclosed embodiments include applying a material (e.g., a lacquer) that serves to dissipate the electrostatic charge. Other components in a film processing system or line, dependent upon the particular product or packaging requirements, could include a grounded machine as well as optional equipment such as described in Table 1, an application method, an applicator tool, as well as a device to measure the electrostatic charge.

Lacquer Coating Material

In one embodiment a film product may include a strategically coated over lacquer. The primary purpose of such a lacquer is to act as a transparent coating to build-up material in an area of the web where zero print coverage occurs. Without the lacquer, in the final roll, this area with zero print coverage would be soft in comparison to the area with print causing a poor roll profile.

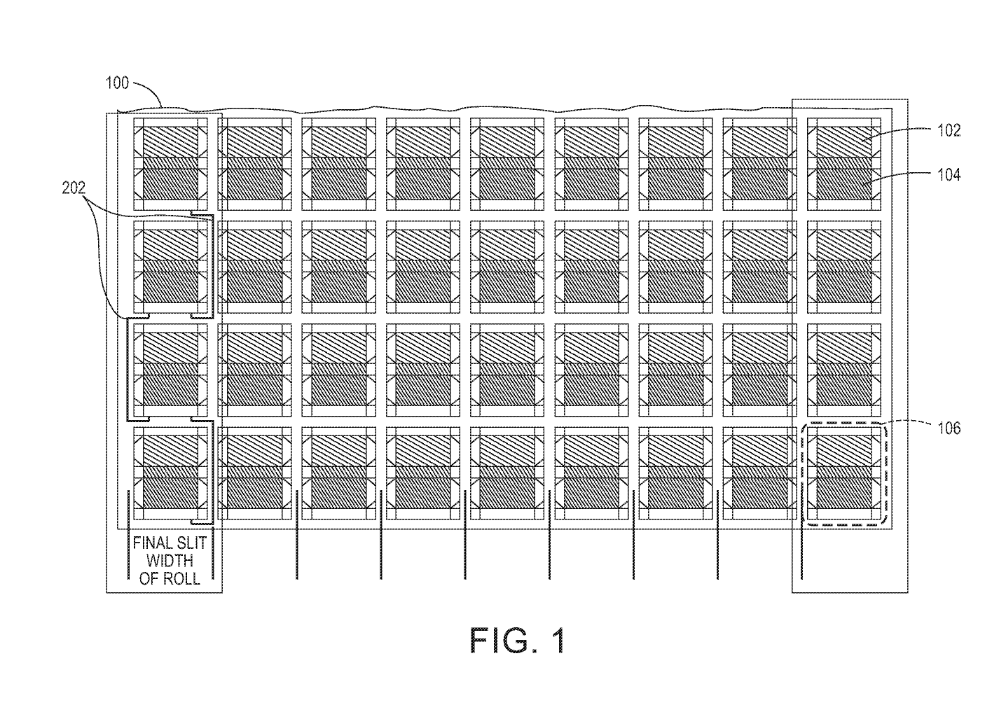

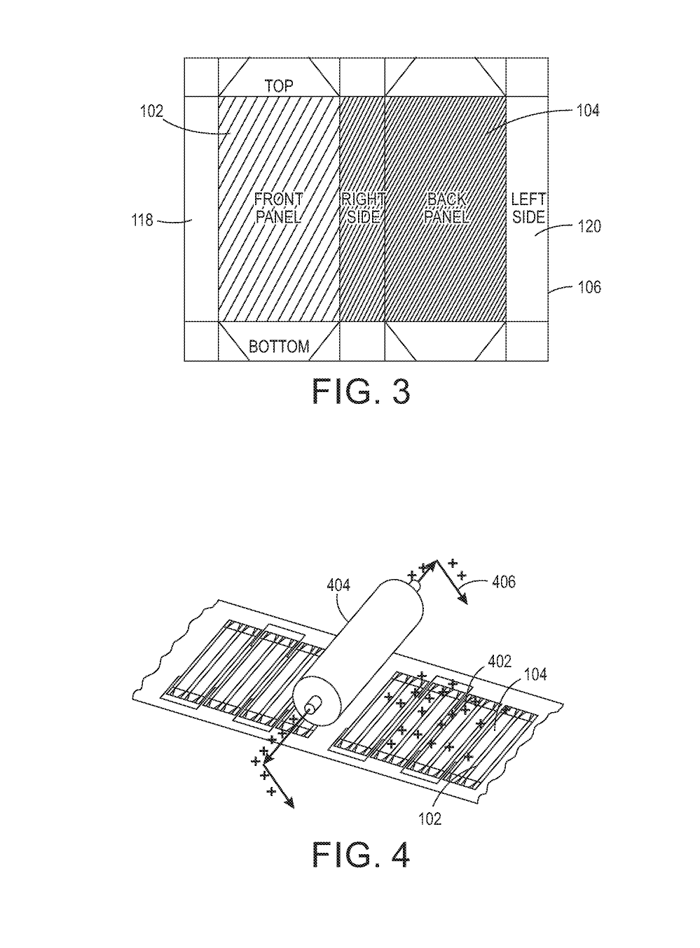

Referring to FIGS. 1-3, depicted therein is a packaging film 100, which is divided or cut into individual wrappers 106 for a carton package such as for cigarettes, pharmaceuticals, etc. Each of the wrappers includes one or more lacquer-coated regions (102, 104) that are selectively placed on the film by process such as a gravure web printing press. The coating in region 102 is a deposition of transparent lacquer on the non-conductive polymer base material that forms film 100. In one embodiment the lacquer coating is only placed in printed areas to protect the layers of printing, or conversely to ensure the adherence or the ink to the film. With respect to coating region 102, coating in region 104 is a relatively thicker layer of lacquer and is applied as illustrated in FIG. 3, possibly to compensate for the additional thickness incurred from the printing. This thickness normalization is employed to ensure the general uniformity of the film/roll profile. In one embodiment the coating in regions 102 and 104, as will be described below, has an additional function of dissipating electrostatic charge by conducting the charge to grounded surfaces and grounding devices (e.g. process machinery) in contact with or proximity to the film, and is intended to prevent or minimize the unintentional use of the operator as a discharge path. One such example is process machinery such as a drive or idler roll 404 and ground path 406 in FIG. 4, where electrostatic charge 402 can be dissipated by direct contact or proximity to the film surface, particularly coated regions 102 and 104.

As FIG. 3 further illustrates, in one embodiment, the lacquer coated areas or regions 102 and 104 are within the individual wrapper 106 for one carton. The heavier-shaded region 104 may have a thicker deposition of lacquer to build up material for better roll profile. The lighter-shaded region 102 is a lighter or thinner deposition of lacquer to protect the layers of ink that are printed in order to accurately reproduce the graphics on the wrapper's front panel. As noted above, in one of the disclosed embodiments, the coating (e.g., lacquer) is selectively applied to only pre-defined regions 102, 104 on the film, thereby leaving adjacent spaces uncoated and suitable for subsequent package processing techniques (e.g., cutting/trimming, folding, adhesive or heat sealing, and the like) so the coating will not preclude or impact such processes and operations. However, having isolated patches of a dissipative coating may substantially reduce the capacity of the film to dissipate static charge and thereby preclude management of electrostatic discharge.

To create an electrical current path to discharge excess electrostatic charge built up on the film, a coating with a certain conductivity level may be applied on the OPP film 100 to help dissipate or equalize the charge. There are many conductive coatings in the printing and electronics industry, and the disclosed embodiments are not specifically limited to one material, but may include several materials or a combination of such coating materials.

Nonetheless, there are certain criteria that are necessary to make the coating function in accordance with the disclosed embodiment. One that is paramount is that the coating lacquer or material must be transparent so as to enable or allow underlying printing, graphics, etc. to be seen through the coating. The second characteristic is that the material, when applied to and dried on the surface of film 100, must be conductive or at least dissipative for static charge. Based on the specific application, there are a number of generic requirements for a coating on a film that is conductive. Foremost is that the coating must provide the OPP film with a static dissipative property such as a surface resistance that may be less than conductive yet in the dissipative range, for example, a surface resistance greater than 10 kilohms but less than 100 gigohms when tested according to ANSI/ESD STM11.11 or a volume resistivity greater than 1.0×105 ohm-cm but less than or equal to 1.0×1012 ohm-cm when tested according to the methods of ANSI/ESD STM11.12 may provide the appropriate dissipative response to a static charge.

Additionally the coating should have a viscosity and drying time that is compatible with the required coating process (e.g., gravure roll printing). In certain applications the coating needs to be non-toxic in order to meet product integrity guidelines dictated by the products being packaged. The list below includes several transparent conductive coatings, which may be used individually or in combination with one another or other coatings:

Indium Tin Oxide;

Aluminum Oxide;

Silver Nanowires;

Carbon Tubes;

Doped Zinc Oxide;

Graphene; and

Polythiophenes.

### Experimental Example A

### Conductive Ink Pens

To prove the concept that a conductive coating could facilitate electrostatic dissipation, an experiment was conducted using a conductive silver ink pen, printed OPP film, a field static meter, and a grounded rewinding machine.

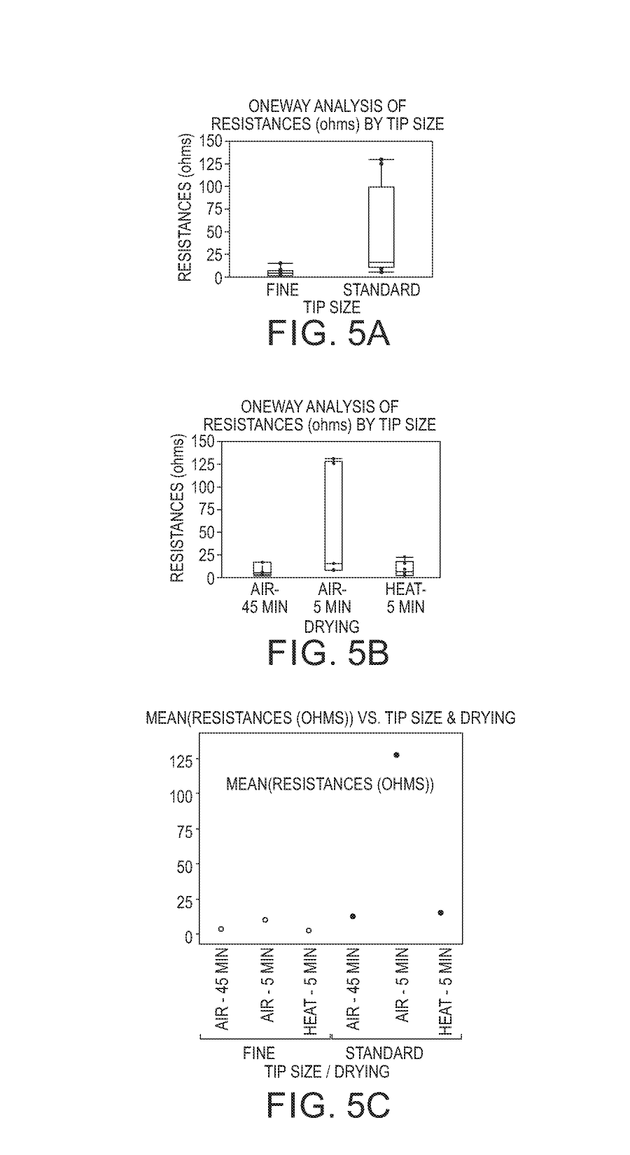

Pens containing silver ink (a conductive ink), manufactured by ITW Chemtronics (CircuitWorks® Conductive Pen) were considered. Two styles of pens were selected, one with a fine tip and the other with a thicker, standard tip. Tests were conducted to determine the conductivity of each pen style and predicted process parameters for production. The charts in FIGS. 5A-5C show results confirming that a fine tip with heat drying for five minutes has a lower resistance (higher conductivity), measured in ohms, than the standard tip pen.

With the fine tip pen, the experiment continues to show how a trace of conductive ink can be employed to create an electric current path to dissipate or conduct the electrostatic charge. In this case ink containing a certain concentration of silver is confirmed to be suitable to dissipate static charge.

### Experimental Example B

### Conductive Ink Traces On OPP Film

The following addition was made to an OPP film to test the dissipation effect of silver traces from the conductive ink pens of Example A, again using silver traces. More specifically traces were drawn in varying frequencies (separation distances), across the film web having a width of approximately 5.3 inches. Traces were drawn at:

100 feet;

Every pattern repeat—approximately 6.653 inches;

Every cylinder repeat—approximately 26.612 inches; and

Control—no silver ink traces.

Once the traces were applied to each roll in the spacing (frequency) indicated above, the rolls of film were placed on a rewinding machine. Also note that the beginning and end of the rolls do not have conductive traces in order to measure a “control” static level. While running the rewinding machine, static was measured with a field static meter. At the beginning of the roll, where no conductive trace was applied, the measurements demonstrated a higher level of electrostatic charge. As the film on the roll material transitioned to the portion where conductive trace material was present, the field static meter was able to measure a change in electrostatic charge. Furthermore, the roll or web does contact idle rollers on the machine, which is in turn grounded through the floor.

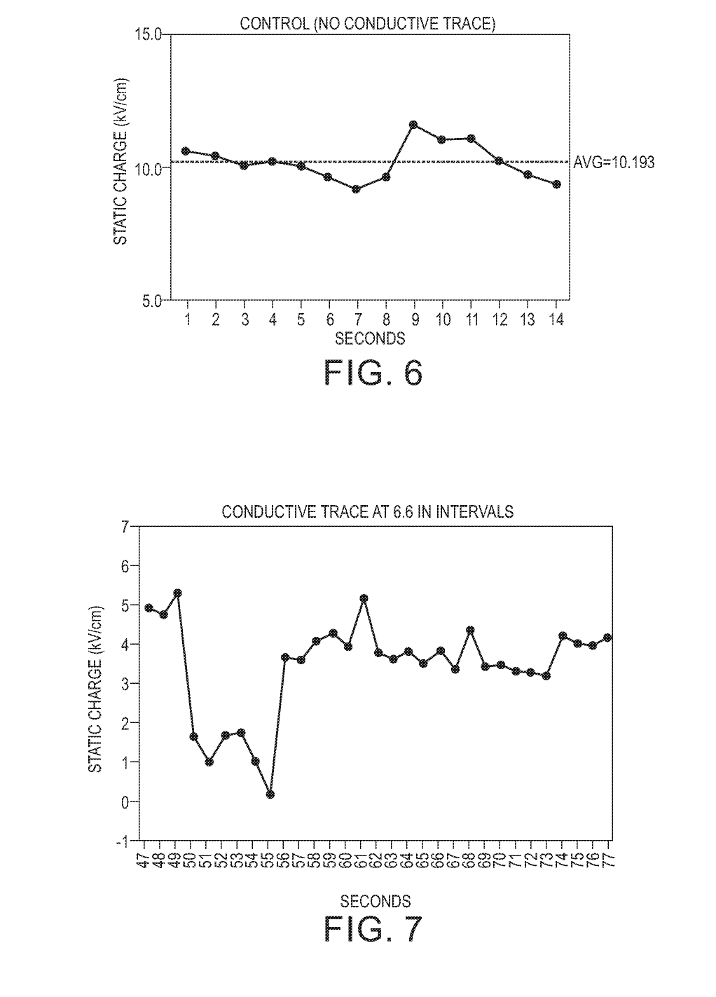

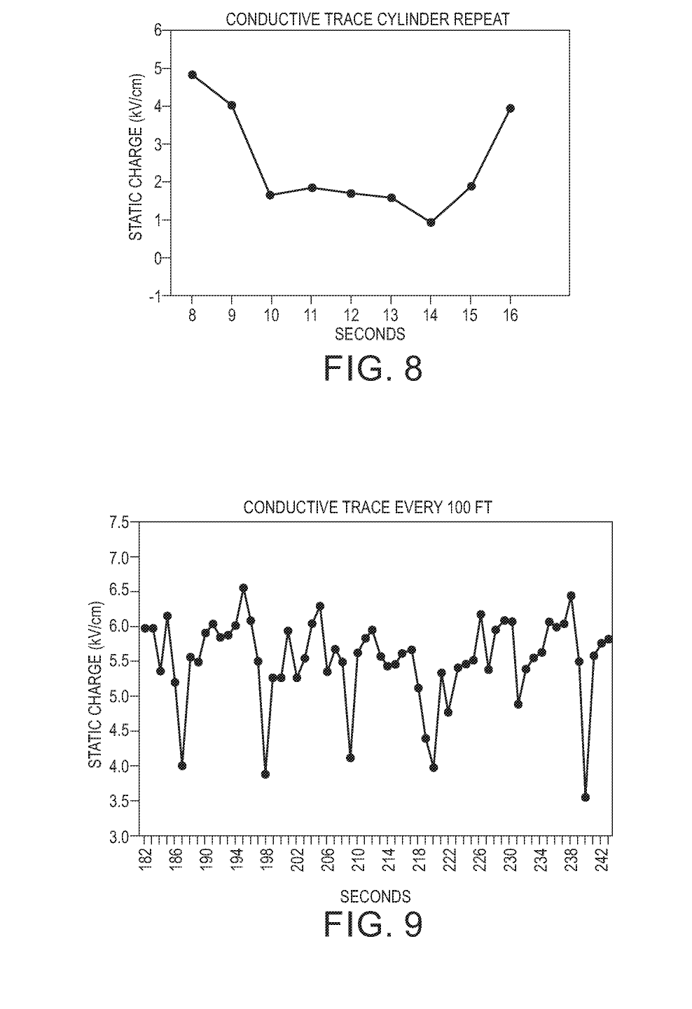

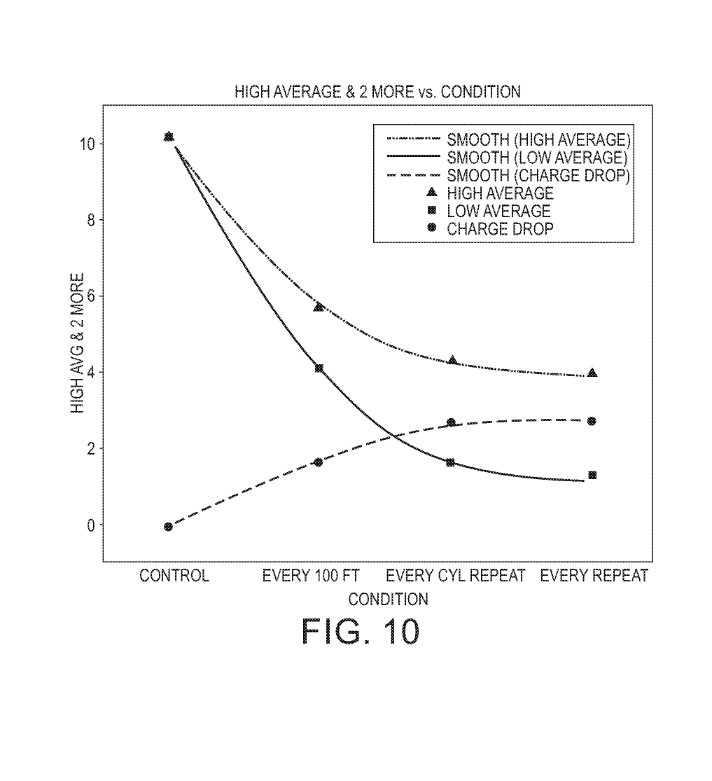

Static changes were measured with a field static meter measuring in the kilovolt (kV) range. The results indicate that when the conductive traces pass over the idler roller, the static charge drops in comparison to where the web does not contain conductive traces (see FIGS. 6-10). Accordingly, the use of a conductive material on a surface of the film appears to significantly limit the level of static that is built up or at least serves to dissipate such charge. As will be understood from a review of FIGS. 6-9, the control (uncoated, no trace) portions of the web exhibited static charge levels in the range of 10 kV, whereas the presence of traces of some form were suitable to dissipate the charge by several kV, and even into the 4 kV and lower levels. Table 2 (below) summarizes the test data depicted in FIG. 10:

TABLE 2

| | High Avg. | Low Avg. | Charge Drop |
|---|---|---|---|
| CONDITION | (kV) | (kV) | (kV) |
| Control | 10.2 | 10.2 | 0 |
| Every Repeat | 4.0 | 1.3 | 2.7 |
| Every Cylindrical Repeat | 4.3 | 1.6 | 2.7 |
| Every 100 ft. | 5.7 | 4.1 | 1.6 |

The modified film and process described above was indicative of a strong likelihood of success in scaling up to a production environment, particularly where the conductive ink can be implemented by substituting a transparent, conductive lacquer coating for a lacquer coating currently applied to the OPP film. Factors that may be key to the selection of a transparent conductive coating suitable to be employed as a lacquer include:
(i) Transparency—should be equal to or more transparent to current lacquer;
(ii) Conductivity—at a level high enough (i.e., resistance low enough) to dissipate electrostatic charge;
(iii) Viscosity—must be in a range compatible with gravure printing or other processes suitable to apply registered coating layers on an OPP film;
(iv) Drying—solvents that are compatible for gravure printing requirements or with alternative application techniques; and
(v) Product Integrity (PI)—must contain components that are acceptable for packaging standards, which may be dependent upon product being packaged (e.g., tobacco).

A packaging film incorporating the properties proposed herein, includes a film substrate or web 100 such as biaxially oriented polypropylene, and a conductive lacquer applied in a plurality of separately patterned regions on at least one surface of the film to dissipate static created during the processing and handling (e.g., printing, moving, slitting, rerolling, transporting) of the film during its manufacture and converting, and subsequent handling during its use as a packaging material. Moreover, in one of the disclosed embodiments the conductive lacquer regions are electrically interconnected to one another by traces 202 to provide a path to dissipate the static charges and thereby remove or at least equalize such charges across surfaces—including personnel coming into contact. While various materials are contemplated for producing the conductive pattern regions and traces, such materials should be suitable for use with conventional film printing techniques and may include components such as: Indium Tin Oxide; Aluminum Oxide; Silver Nanowires; Carbon Tubes (including nanotubes); Doped Zinc Oxide; Graphene; Polythiophenes as well as other organic or inorganic materials that either have conductive properties, or at least demonstrate the ability to lower the resistance of the dried material and produce a dissipative coating. In one embodiment, the film with the dried coating or lacquer thereon exhibits a surface resistance in the static dissipative range (e.g., a surface resistance greater than 10 kilohms but less than 100 gigohms).

### Example C

### Conductive Lacquer Applied to OPP Film

In one embodiment, a coating available from Sun Chemical may be utilized to meet the above criteria. The coating may be a specifically formulated coating for this application or may be a known lacquer including one or more of the conductive materials noted above. It is understood that the material and application may be unique or customized to meet the requirements for a particular industry (e.g., tobacco) and for the targeted application of dissipating electrostatic charge.

Application Process

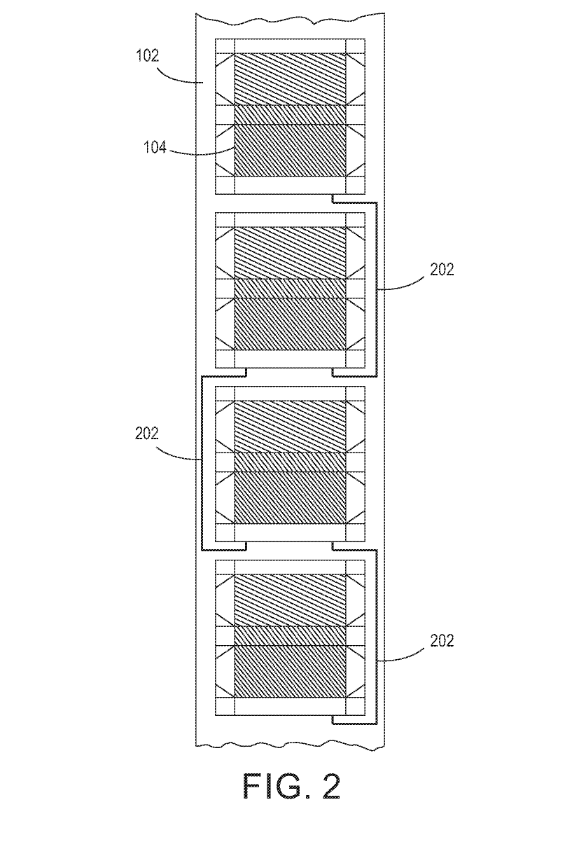

The conductive lacquer is applied via a gravure printing method, although other registered printing methods may be used as well. A gravure cylinder which has an engraving to collect and deposit the liquid to form the lacquer areas on the film will be the deposition tool that applies the lacquer to the substrate/OPP packaging material. The engraving layout may or may not need to have modifications, including interconnections between adjacent regions. It is believed that interconnecting lacquer patches, for example using traces 202, as illustrated in FIGS. 1 and 2, may further increase the ability to dissipate the charge via a continuous path and thereby reduce the electrostatic charge via the path. In other words, the lowered resistance or continuity throughout the length of the gravure-printed film web will increase the likelihood of electrical charge dissipation through a grounded machine or other components coming into contact or proximity with the surface of the film web.

The functionality of the unique combination of the transparent, conductive lacquer and application method can be actualized as the OPP web passes over and in contact with idle rollers on a printing machine, a slitting machine, and a packaging line. The diagrams of FIGS. 1 and 2 illustrate the path created for dissipation of the excess electrostatic charge on an exposed web of OPP. As will be appreciated, in order to avoid interfering with package folding and sealing regions, the traces 202 between adjacent wrapper regions, or more particularly, lacquer regions 102 and 104, are connected at or to the heavier lacquer regions 104, thereby providing a conductive trace running the length of the slit film roll. Moreover, traces 202 may be applied to avoid overcoating surfaces that are to be sealed, such as the left-most central region (118) which is sealed to the under-surface of the left side region 120 in a carton package layout such as depicted in FIG. 3.

The disclosed embodiments result in one or more of the following advantages:
provide higher level of safety to the gravure printing process; high levels of electrostatic charge pose potential for sparks and subsequent potential explosions in a solvent ink printing environment;
on converting lines, operators will no longer experience electrostatic discharge as they currently do while running printed OPP overwrap films; and
the consumer will have a more satisfying experience in unwrapping the printed OPP film. Currently, the electrostatic charge in the film causes a clinging effect between the film and the consumer's hand while removing the film from the carton and disposing of the film in a trash receptacle.

In summary the process generally described above for producing a packaging film, includes: providing a film substrate (e.g., OPP) and applying to a surface of the film substrate, a patterned conductive lacquer to dissipate static created by handling of the film (e.g., moving, rolling, transporting, etc.). The desired dissipation of electrostatic charge may be accomplished by placing a grounded conductor into proximity or direct contact with the patterned lacquer regions and/or traces. Furthermore, the patterned lacquer is applied using a gravure printing method, or at least an alternative method that enables the accurate registration of the material being deposited. Such a method further contemplates providing an interconnection (e.g., by traces) of the conductive lacquer between the patterned lacquer regions, thereby providing a continuous dissipation path for at least a substantial length of the film roll.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A packaging film, including:
a film substrate; and
a conductive lacquer applied in a plurality of separately patterned regions on a surface of said film substrate to dissipate a static charge created on the surface of said film substrate.

2. The packaging film according to claim 1, wherein a plurality of the patterned regions are each electrically interconnected to to conduct charge and dissipate static.

3. The packaging film according to claim 1, wherein said lacquer includes a component selected from the group consisting of: indium tin oxide; aluminum oxide; silver nanowires; carbon tubes, carbon nanotubes; doped zinc oxide; graphene; and polythiophenes.

4. The packaging film according to claim 1, wherein the conductive lacquer is transparent.

5. The packaging film according to claim 1, wherein the film exhibits a surface resistance in a static dissipative range.

6. The packaging film according to claim 5, wherein the film exhibits a surface resistance greater than 10 kilohms but less than 100 gigohms.

7. A method of producing a packaging film, including:
providing a film substrate;
applying, to a surface of said film substrate, patterned conductive lacquer regions to dissipate static.

8. The method according to claim 7, wherein dissipation is accomplished by placing a grounded conductor in proximity with the patterned lacquer regions.

9. The method according to claim 8, wherein proximity includes occasional contact between the grounded conductor and the patterned lacquer regions.

10. The method according to claim 7, wherein applying the patterned lacquer regions is accomplished using a gravure printing method.

11. The method according to claim 7, further including providing an interconnection trace using the conductive lacquer applied between the patterned lacquer regions.

12. The method according to claim 7, wherein the conductive lacquer is transparent.

13. The method according to claim 11, wherein the interconnection trace is applied to avoid overcoating an end seal region of a package.

14. The method according to claim 7, further comprising at least one handling operation to convert the film for use in wrapping a carton, wherein said at least one handling operation includes placing a grounded conductor in proximity with the patterned lacquer regions.

15. The method according to claim 14 wherein said at least one handling operation is selected from the group consisting of: moving, rolling, transporting, printing, and slitting said film.
